(19) United States
(12) Patent Application Publication
(10) Pub. No.: US 2005/0129376 A1
(43) Pub. Date: Jun. 16, 2005

(54) Alkali-doped optical fiber preform and method of making same

(76) Inventors: Benjamin Z. Hanson, New York, NY (US); Michael T. Murtagh, New York, NY (US); Pushkar Tandon, New York, NY (US)

Correspondence Address: CORNING INCORPORATED, SP-TI-3-1, CORNING, NY, 14831, US

(21) Appl. No.: 11/008,396

(22) Filed: Dec. 8, 2004

Related U.S. Application Data
(60) Provisional application No. 60/529,024, filed on Dec. 12, 2003.

(51) Int. Cl. G02B 6/02

(52) U.S. Cl. 385/123

(57) ABSTRACT

Disclosed is an alkali-doped optical fiber perform and method for making the same. A silica glass member, such as a rod or the like is heated in a furnace chamber at a temperature of less than 75° C. below the softening point of the glass rod in an environment containing an alkali metal vapor to form an alkali metal oxide doped glass rod. This method provides a peak concentration in the outer half portion of the silica glass member. The alkali metal oxide doped glass member may be overclad with additional glass to form an optical fiber preform ready for drawing into an optical fiber. Alternatively, the alkali metal oxide doped glass member may be inserted into a porous, glass soot optical fiber preform or inserted into a tube comprising solid glass.

### BACKGROUND OF THE INVENTION

1. Field Of The Invention

The present invention relates generally to an optical fiber perform and a method of making an optical fiber preform, and more specifically to an alkali-doped optical fiber perform and a method of making an optical fiber preform doped with an alkali metal oxide.

2. Related Applications

The present invention claims priority to an the benefit of U.S. Provisional Patent Application No. 60/529,024 filed Dec. 12, 2003, the disclosure of which is hereby incorporated by reference herein.

### TECHNICAL BACKGROUND

Attenuation is a principal limiting attribute of optical fibers. Optical fiber loss, for example, plays an important role in setting the limiting distance between optical fiber amplifiers. This is particularly important in long distance and ultra-long distance networks such as, for example, undersea applications, where such amplifiers represent a significant system cost, as well as a major factor in system reliability. Consequently there is tremendous commercial interest in reducing attenuation to the lowest possible level.

Silica glass doped with an alkali metal oxide has been shown to be capable of reducing attenuation in optical fibers. Nevertheless, prior art methods of making optical fibers doped with an alkali metal oxide have been impractical for large manufacturing operations.

### SUMMARY OF THE INVENTION

One broad aspect of the present invention relates to a method of making an optical fiber preform comprising heating an optical fiber precursor in a furnace, exposing the optical fiber precursor to an environment comprising an alkali metal vapor to form an optical fiber precursor doped with an alkali metal oxide, and wherein the alkali metal vapor comprises an alkali metal selected from the group consisting of K, Na, Li, Cs, Rb, and combinations thereof. Preferably, the exposing step is performed for a period of time effective to dope the optical fiber precursor with a concentration of the alkali metal oxide greater than about 0.01 wt. %, more preferably for a period of time effective to dope the optical fiber precursor with a concentration of the alkali metal vapor between about 0.1 wt. % and about 5 wt. %; more preferably 1.0 to 3.0 wt. %; and most preferably 1.0 to 2.0 wt. %. Preferably, the optical fiber precursor is exposed to the alkali metal vapor for at least about 6 hours, more preferably at least about 12 hours, and most preferably between about 12 hours and 72 hours. Preferably, a peak concentration of alkali metal oxide at a first point of the alkali metal oxide doped optical fiber precursor is no more than about 15% greater than a peak concentration of alkali metal oxide at a second point of the alkali metal oxide doped optical fiber precursor. Preferably, the method includes forming additional glass on the alkali metal oxide doped optical fiber precursor. The additional glass is preferably formed by inserting the alkali metal oxide doped optical fiber precursor into a centerline hole of a glass tube; preferably, the glass tube is comprised of glass soot. Optionally, the additional glass may be formed by depositing glass soot onto the alkali metal oxide doped optical fiber precursor. According to one embodiment, the alkali metal oxide doped optical fiber precursor comprises GeO₂. The method may include the step of drawing an optical fiber from an optical fiber preform comprising the alkali metal oxide doped optical fiber precursor.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention. Where appropriate, identical features have been identically numbered.

### BRIEF DESCRIPTION OF THE DRAWINGS

FIG. 1 is diagram of a method of making an optical fiber preform proposed by the present invention.

FIG. 2 is a side cutaway view of an apparatus for doping an optical fiber precursor with an alkali metal oxide.

FIG. 3 is a side view of an apparatus for depositing additional glass onto the alkali doped optical fiber precursor according to a further aspect of the invention.

FIG. 4 is an isometric view of a rod-in-tube method of providing additional glass onto the alkali doped optical fiber precursor according to another aspect of the invention.

FIG. 5 is an graphic view illustrating the Alkali wt. % vs. radius of the perform according to another aspect of the invention.

FIG. 6 is an isometric view of a rod-shaped preform according to another aspect of the invention.

FIG. 7 is a side view of an apparatus for performing one preferred method of the invention.

### DETAILED DESCRIPTION OF THE INVENTION

According to the present invention, a method of making an optical fiber is proposed which includes doping an optical fiber precursor with an alkali metal oxide. The alkali metal oxide is preferably an oxide of K, Na, Li, Cs, or Rb, or a mixture thereof; more preferably the alkali metal oxide is K₂O, Rb₂O, Cs₂O or mixtures thereof, and most preferably the alkali metal oxide is K₂O or Rb₂O. Preferably, the peak concentration of alkali metal oxide in the optical fiber precursor is at least about 0.01 wt. %; more preferably at least about 0.1 wt. %; more preferably between about 0.1 wt. % and 5 wt. %; more preferably between 1.0 wt. % and 3.0 wt. %; and most preferably between about 1.0 wt. % and 2.0 wt. %.

The optical fiber precursor may be made by conventional methods, including outside vapor deposition (OVD), vapor axial deposition (VAD) or modified chemical vapor deposition (MCVD). For example, a silica preform may be made using conventional OVD techniques wherein a glass soot producing burner may be used to deposit glass soot onto a target rod to form a soot preform. The amount of glass soot is preferably greater than about 2000 g. Preferably the soot preform has a density between about 0.35 g/cc; more preferably between about 0.35 g/cc and 0.5 g/cc. The glass soot may be pure silica, or the glass soot may be doped to achieve a desired central core refractive index profile. Suitable dopants include Ge, P, F, Al and B.

The target rod is removed from the soot preform leaving a hole extending along a centerline of the soot preform. The soot preform is then dried by conventional methods to remove residual water, and consolidated to form a clear, solid glass. By water we mean the hydroxyl radical OH. OH is responsible for an absorption peak at or about 1383 nm and which absorption peak may extend into the operating wavelength regions of an optical fiber. This peak may have a detrimental effect on the fiber attenuation. Preferably, the soot preform contains less than about 100 ppb by wt. OH after drying; more preferably less than about 20 ppb by wt. Preferably, chlorine drying is used.

More particularly, the soot preform is preferably dried by heating the soot preform to a temperature of at least about 1000° C. in an atmosphere comprising chlorine for at least about 1 hour. Preferably, the soot preform is heated to a temperature of between about 1000° C. and 1200° C. Preferably also, the atmosphere contains at least about 1% chlorine by volume; more preferably at least about 2% by volume. The soot preform is more preferably dried for at least about 2 hours; and may be dried for about 3 hours or more.

To remove, or scavenge, residual chlorine that may remain in the soot preform after the drying step, the soot preform is preferably further heat treated at a temperature of greater than 800° C., more preferably about 1000° C., in a chlorine scavenging atmosphere such as, for example, an atmosphere comprising F. Suitable atmospheres comprising F include, for example, the fluorine-containing gases CF₄ or SiF₄. Preferably, the fluorine-containing gas is in a concentration of at least about 1% by volume; more preferably at least about 2% by volume. Alternatively, the chlorine scavenging atmosphere may comprise bromine. Preferably, the bromine containing atmosphere comprises bromine in a concentration of at least about 1% by volume; more preferably at least about 2% by volume. For example, liquid bromine may be bubbled to form gaseous bromine and mixed with O₂ or an inert gas, such as He or Ar. Preferably, the chlorine content of the soot preform after exposure to the chlorine-scavenging gas is less than about 0.05 wt. %; more preferably less than about 0.02 wt. %; and most preferably less than about 0.01 wt. %.

Once residual chlorine has been scavenged from the soot preform, the soot preform is consolidated into a clear glass article which is preferably substantially chlorine free. The soot preform is consolidated by heating the soot preform to a temperature of at least about 1450° C.; more preferably at least about 1500° C. Drying and consolidation of the soot preform may be accomplished by using a conventional consolidation furnace.

The clear glass article (sometimes referred to as a consolidated preform) is placed in a draw furnace and further drawn (reduced in diameter) according to conventional draw methods. During the draw process, the centerline hole formed in the article by removal of the target rod is preferably closed. This may be accomplished, for example, by reducing the pressure within the centerline hole, wherein ambient atmospheric pressure is sufficient to collapse the hole when the article has reached a suitable draw temperature. The clear glass preform is typically drawn at a temperature greater than about 2000° C. Preferably, the optical fiber precursor produced from the consolidated perform is a glass rod having a diameter of at least about 2 mm; more preferably at least about 3 mm, and most preferably at least about 5 mm; and most preferably between about 3-15 mm. The drawn rod is preferably cut into a plurality of shorter sections. The shorter sections preferably have a length of at least about 1 meter and comprise the optical fiber precursor.

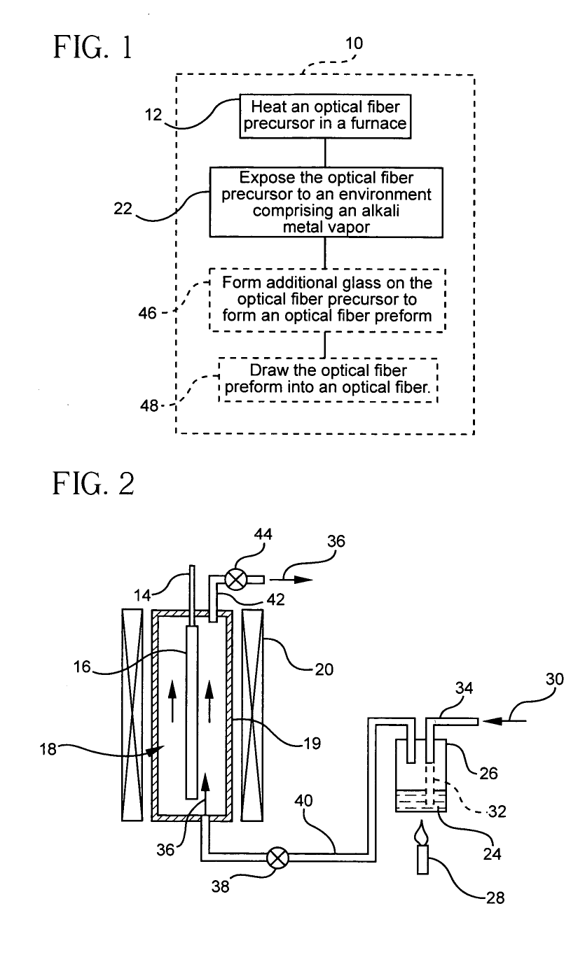

FIG. 1 is a diagram of the preferred method 10 of making an optical fiber preform proposed by the present invention. As indicated by step 12 in FIG. 1, the optical fiber precursor obtained from the process described supra is heated in a furnace. An illustration of a suitable furnace is shown in FIG. 2. As shown in FIG. 2, a handle 14 is attached (for example by welding or fusing or otherwise mechanically mounting or attaching) to a first end of the optical fiber precursor 16 resulting from the drawing step described supra, and the optical fiber precursor is placed in a furnace chamber 18 having generally cylindrical walls 19. Handle 14 serves to support the optical fiber precursor in furnace chamber 18. Furnace chamber 18 is heated by heating element 20. Heating element 20 preferably surrounds the walls and such element may be, for example, a resistance heater. As illustrated by step 22 of method 10 in FIG. 1 and shown in FIG. 2, optical fiber precursor 16 housed in furnace chamber 18 is exposed to an atmosphere comprising an alkali metal vapor. The alkali metal vapor may be formed, for example, by heating a suitable alkali metal source compound 24 held in vaporization chamber 26 wherein vaporization chamber 26 is heated by heat source 28 to form an alkali metal vapor. Heat source 28 may be, for example, a combustion burner or resistance heater. Vaporization chamber 26 is in fluid communication with furnace chamber 18. For example, vaporization chamber 26 may be connected to furnace chamber 18 through a piping system as shown in FIG. 2 including, for example, pipe 40 and valve 38. Preferably, the piping system is comprised of a material which does not readily react with the alkali metal vapor. The piping system may be comprised of glass or Hastalloy, for example. The alkali metal vapor is transported to furnace chamber 18 by flowing a carrier gas (represented by arrow 30) from a carrier gas source (not shown) through vaporization chamber 26. The carrier gas preferably comprises oxygen. Preferably, the carrier gas is flowed at a rate of at least about 0.5 liters/min, more preferably between about 0.5 liters/min and about 3 liters/min; most preferably between about 1 liters/min and 2 liters/min. The carrier gas preferably comprises at least about 15% oxygen; more preferably at least about 20% oxygen. Oxygen concentrations of up to about 100% may be used. The carrier gas may be flowed into vaporization chamber 26 in such a way that the carrier gas flows over the top of the heated alkali metal source compound 24, or by flowing the carrier gas through the alkali metal source compound (referred to as bubbling), as indicated by dotted line extension 32 to carrier gas inlet 34. The alkali metal source compound 24 preferably comprises an alkali metal selected from the group consisting of K, Na, Li, Cs, Rb, and combinations thereof. Preferably, the alkali metal source compound is an iodide, bromide or a chloride of the alkali metal. For example, the alkali metal source compound may be KBr, KCl or KI. Prior to flowing the carrier gas 30 and alkali metal vapor into furnace chamber 18, furnace chamber 18 is preferably purged by flowing an inert gas through furnace chamber 18 to remove any contaminant gases. Preferably, the inert gas is helium or argon.

The optical fiber precursor 16 is placed in furnace chamber 18 and heated in furnace chamber 18 at a temperature preferably below the softening point of the optical fiber precursor; more preferably at a temperature between about 1600° C. and 2100° C., even more preferably at a temperature of between about 1700° C. and about 2100° C., and most preferably at a temperature between about 1800° C. and 2100° C. Higher temperatures are preferred as they promote more rapid diffusion of alkali metal oxide within the optical fiber precursor 16.

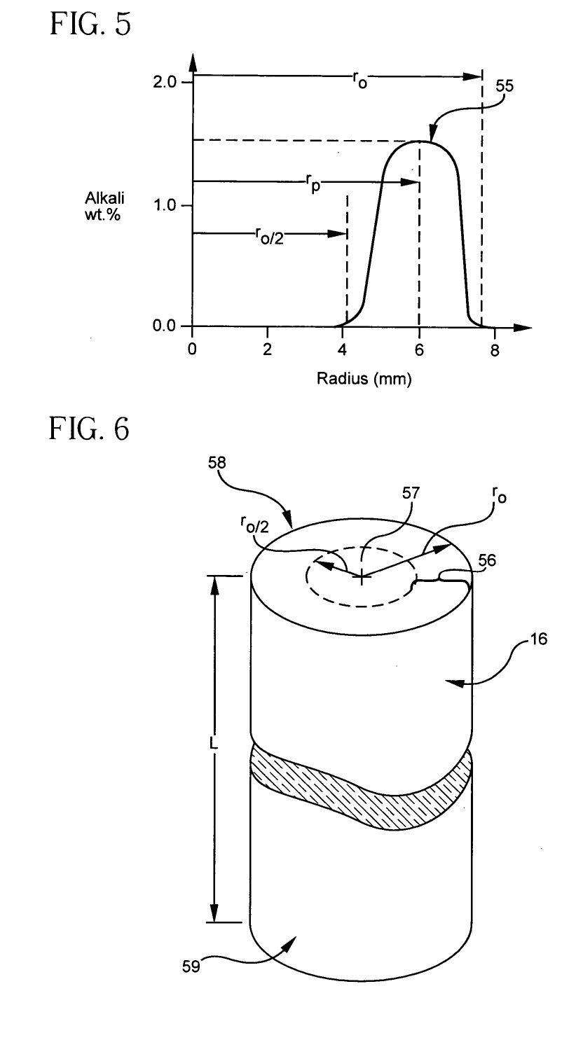

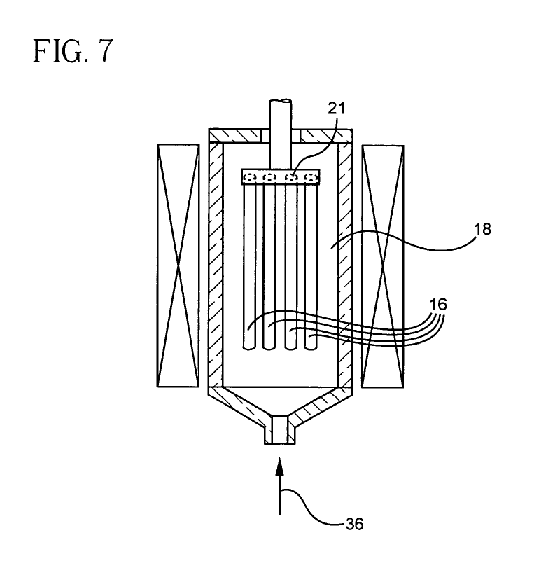

When the optical fiber precursor has reached an equilibrium temperature in the range described supra, the combined flow of carrier gas and alkali metal vapor (indicated by arrows 36) from vaporization chamber 26 to furnace chamber 18 is begun. Flow of the carrier gas and alkali metal vapor may be controlled, for example, by valve 38 shown in piping 40 connecting vaporization chamber 26 and furnace chamber 18 as illustrated in FIG. 2. An exhaust port 42 and exhaust valve 44 may be provided in furnace chamber 18 to control the exhaust carrier gas and alkali metal vapor. Preferably, the optical fiber precursor is exposed to the alkali metal vapor in furnace chamber 18 for at least 6 hours, more preferably at least about 12 hours; and most preferably between about 12 hours and 72 hours, or possibly even longer depending upon the peak concentration desired. Preferably the alkali metal vapor and carrier gas flows between the outside surface of the precursor 16 and the walls 19 of the furnace chamber 18 and the alkali metal oxide is exposed to the outside of the precursor and is resultantly diffused into the optical fiber precursor. Diffusion preferably results in a peak concentration of greater than about 0.1 wt. %, more preferably between about 0.1 wt. % and 5 wt. %; even more preferably between about 1.0 wt. % and 3.0 wt. %, and most preferably between about 1.0 wt. % and 2.0 wt. %. In more detail, because the doping is preferably achieved in a radially inward fashion, i.e., diffusing inwardly from the outside surface, the peak concentration of alkali metal oxide is positioned near the outside dimension of the precursor article, and is most preferably slightly offset therefrom. In particular, according to one embodiment of the invention, the precursor is an elongated silica-containing rod. The rod has a length, L, and an outer radius, rₒ, as shown in FIGS. 5 and 6, and the rod 16 includes a desired concentration of alkali dopant as a function of radius (see, for example, FIG. 5). In particular, the peak concentration 55 of alkali dopant is preferably located at a radius, rₚ, which is preferably located within an outer half portion 56 of the rod 16. That is, the peak concentration 55 is located at a radius located radially outward from the half radius, rₒ/2, as shown in FIG. 6. In addition to the peak concentration 55 being located in the outer half portion 56, preferably no more than 0.5 wt. % of alkali dopant is provided at any point within the inner half portion 57, i.e., within the portion with a radius less than or equal to rₒ/2. Moreover, because diffusing the alkali dopant into the optical fiber perform occurs within a furnace chamber, the concentration of alkali metal oxide from a first end 58 to a second end 59 along the length, L, of the perform 16 is substantially constant. More preferably, the peak concentration of alkali metal oxide at a first location along the length, L, of the perform 16 is no more than 15% greater than a peak concentration of alkali metal oxide at a second location (spaced from the first location) along the length, L, of the perform 16. Within the furnace this is achieved by exposing the preform to a substantially constant temperature along its length. This is achieved by providing a furnace with a hot zone the same length or longer than the preform or by down driving the preform through a shorter hot zone, but at a substantially constant down drive rate. In one preferred method embodiment, multiple rods 16 are simultaneously mounted in, and suspended from, a holder 21 in the furnace chamber 18 at the same time, as shown in FIG. 7. A combined flow of carrier gas and alkali metal vapor flows into the chamber 18 as indicated by arrow 36 while the temperature of the furnace chamber is maintained at the temperature below the softening point listed above. This enables large numbers of rods 16 to be treated within a single treatment cycle wherein each rod has a uniform (generally less than 15% variation) in alkali dopant concentration along their respective lengths.

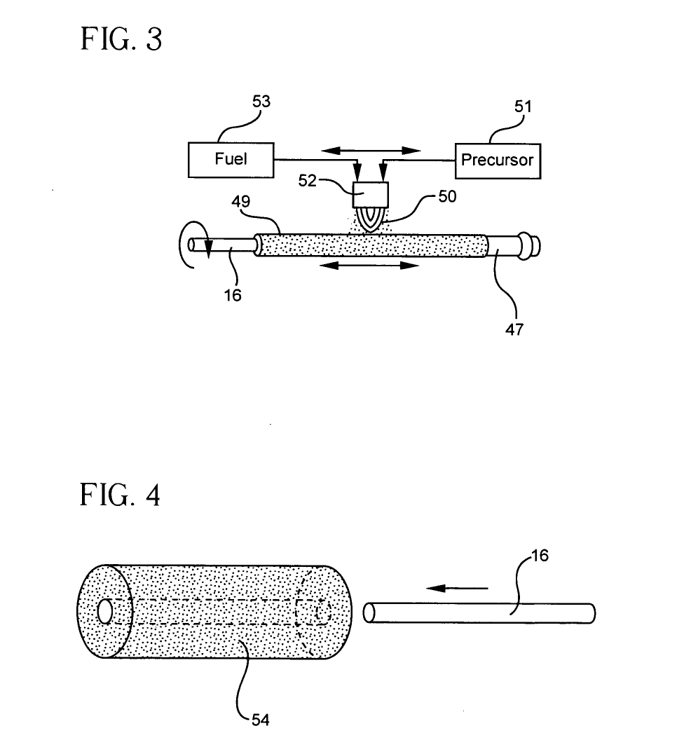

Once diffused with sufficient amount of alkali dopant, the optical fiber precursor may be overclad with additional glass. Preferably, the additional glass is sufficient to form an optical fiber preform ready for drawing into an optical fiber, as shown in optional step 46 of method 10 in FIG. 1. The optical fiber precursor may be overclad by conventional methods, including depositing glass soot onto the optical fiber precursor, or by sleeving the optical fiber precursor with a tube (either consolidated glass or glass soot), then heating and collapsing the additional glass onto the rod 16. FIG. 3 illustrates a conventional deposition process and apparatus for adding additional back-and-forth layers of glass soot onto the outside of the alkali-doped precursor 16. In particular, a handle 47 is added to an end of the precursor and soot 49 is deposited onto the exterior surface of the rotating precursor 16 by hydrolyzing a silica precursor 51 (e.g., SiCl₄ or another suitable silica precursor) in a flame 50 of a burner 52 formed by burning fuel 53, such as CH₄. Suitable other heat sources may be optionally employed. If the optical fiber precursor is overclad with glass soot, the glass soot may then be dried and consolidated by conventional methods, such as the method described previously. If the core is pure silica doped with alkali, then the additional glass may comprise cladding, and is most preferably doped with sufficient fluorine to achieve over 0.3% delta difference relative to the core.

Alternatively, the optical fiber precursor may be overclad with additional glass by employing the deposition of soot, sleeving with a glass tube, or both. A preferred sleeving method involves inserting the precursor rod 16 into a central hole of a sleeve 54 as shown in FIG. 4. The sleeve is preferably formed of glass soot, but may optionally be a consolidated glass sleeve. In the case of a soot sleeve, the assembly is then consolidated. In the case of a rod-in-consolidated sleeve assembly, the sleeve and rod are preferably fused together. In any event, the resulting draw preform comprised of consolidated glass may be drawn by conventional draw methods into an optical fiber comprising an alkali metal oxide dopant, as shown by optional step 48 of method 10 in FIG. 1.

### EXAMPLE 1

Silica glass soot is deposited onto a target rod to form a soot preform. The soot preform comprises GeO₂. The target rod is removed from the soot preform and the resulting soot tube is dried and consolidated. The soot tube is dried by heating the soot tube in an atmosphere comprising chlorine at a temperature of greater than about 1000° C. The atmosphere contains about 2% chlorine by volume. The soot tube is dried for a period of time greater than about 2 hours. When the soot preform has been dried, it is heated at a temperature of about 1100° C. in an atmosphere comprising fluorine for at least 1 hour to remove residual chlorine. The concentration of residual chlorine in the soot preform after exposure to the fluorine environment is less than about 0.05 wt. %.

At the completion of the heating step, the soot preform is consolidated by heating the soot preform in a conventional consolidation furnace to a temperature of about 1480° C. to form a consolidated glass article. The soot preform is driven through the hot zone of the consolidation furnace at a rate of about 4 mm/min.

The glass article is drawn in a conventional draw furnace into an optical fiber precursor. The optical fiber precursor is a glass rod having an outer diameter smaller than the starting glass article. The optical fiber precursor has a diameter of about 3 mm.

The glass rod is then heated in a furnace to a temperature of about 1900° C. A carrier gas comprising oxygen and an alkali metal vapor is flowed into the furnace, wherein the glass rod is exposed to the alkali metal vapor for about 12 hours. The alkali metal oxide doped glass rod has a peak alkali metal oxide concentration of about 2 wt. %. The alkali metal oxide doped optical fiber precursor may be used as the target rod for the deposition of additional glass soot. The composite glass rod-soot article may then be dried and consolidated to form an optical fiber preform. Alternatively, the alkali metal oxide doped solid glass rod may be inserted into a glass tube after which the glass tube is heated and collapsed onto the glass rod to form an optical fiber preform ready for drawing into an optical fiber. The optical fiber preform is drawn into an optical fiber doped with an alkali metal oxide. The optical fiber has a peak concentration of alkali metal oxide of about 0.2 wt. %.

### EXAMPLE 2

In another example, a 4 mm diameter pure silica rod is inserted into a furnace chamber of a consolidation furnace having a hot zone temperature of about 1850° C. KBr or KI is heated to about 1000° C. in a reservoir connected to the furnace as shown in FIG. 3 and a carrier gas, such as oxygen, is flowed over the reservoir at a flow rate of about 1 SLPM thereby providing a flow of alkali dopant gas to the furnace chamber. The outside surface of the rod is bathed in the flow of alkali dopant gas for about 48 hours. Simultaneously, the rod is down-driven into the hot zone of the furnace (over and over) at a substantially constant rate of between about 14 mm/min. As the rod traverses through the hot zone in the presence of the alkali doping gas, the alkali dopant is desirably diffused into the rod from the outside in. At this rate and concentration of alkali dopant gas, a suitable level of alkali dopant is diffused into the rod typically providing between 1-2% potassium in the rod. A typical dopant profile for the core cane rod is shown in FIG. 5, for example. According to this method, the alkali dopant is diffused into the rod near the surface thereof. In particular, peak concentrations of the alkali dopant will be preferably offset from the center of the rod, and also preferably from the outside surface of the rod. The suitably alkali-doped rod may then be inserted in a fluorine-doped silica tube to form an assembly. To achieve a delta of about −0.35%, a sleeve is first formed by depositing silica soot onto a mandrel by OVD. The mandrel is removed and the sleeve is then preheated to about 1125° C. for 60 min. Next, the sleeve is chlorine dried for about 120 min. at about 1225° C. with a flow of about 5 slpm He and 0.15 slpm Cl₂ followed by a purge for about 30 min. at about 1125° C. with about 5 slpm He. The sleeve is then consolidated by subjecting it to an atmosphere containing SiF₄ and helium (preferably a flow of about 1 slpm SiF₄ and 19 slpm He) at about 1460° C. and a down drive rate through the hot zone of between 6-20 mm/min. Optical fiber may be drawn therefrom by conventional methods.

It will be apparent to those skilled in the art that various modifications and variations may be made to the present invention without departing from the spirit and scope of the invention. Thus it is intended that the present invention cover the modifications and variations of this invention provided they come within the scope of the appended claims and their equivalents.

1. A method of making an optical fiber preform comprising the steps of:
heating an optical fiber precursor in a furnace chamber;
exposing the optical fiber precursor to an environment comprising an alkali metal vapor to form an optical fiber precursor doped with an alkali metal oxide; and
wherein the alkali metal vapor comprises an alkali metal selected from the group consisting of K, Na, Li, Cs, Rb, and combinations thereof.

2. The method according to claim 1 wherein the heating step comprises heating the optical fiber precursor to a temperature less than a softening temperature of the optical fiber precursor.

3. The method according to claim 2 wherein the optical fiber precursor is heated to a temperature between about 1600° C. and 1900° C.

4. The method according to claim 2 wherein the optical fiber precursor is heated to a temperature between about 1600° C. and 2100° C.

5. The method according to claim 1 wherein the exposing step is performed for a period of time effective to dope the optical fiber precursor with a concentration of the alkali metal oxide greater than about 0.01 wt. %.

6. The method according to claim 5 wherein the exposing step is performed for a period of time effective to dope the optical fiber precursor with a concentration of the alkali metal vapor at least about 0.1 wt. %.

7. The method of claim 1 wherein the step of exposing further comprises exposing an outside of the optical fiber precursor to the alkali metal vapor.

8. The method of claim 1 wherein the step of exposing further comprises flowing the alkali metal vapor between walls of the furnace and an outside of the optical fiber precursor.

9. The method according to claim 1 wherein a concentration of alkali metal oxide from a first end to a second end along a length of the alkali metal oxide doped optical fiber precursor is substantially constant.

10. The method according to claim 1 wherein during the step of exposing, the optical fiber precursor is heated to substantially a same temperature from a first end to a second end along a length thereof.

11. The method according to claim 1 wherein a concentration of alkali metal oxide at a first end of the alkali metal oxide doped optical fiber precursor is no more than about 15% greater than a concentration of alkali metal oxide at a second end of the alkali metal oxide doped optical fiber precursor.

12. The method according to claim 1 further comprising a step of forming additional glass on the alkali metal oxide doped optical fiber precursor.

13. The method according to claim 12 wherein the step of forming additional glass comprises depositing glass soot onto an outside of the alkali metal oxide doped optical fiber precursor.

14. The method according to claim 12 wherein the step of forming additional glass comprises inserting the alkali metal oxide doped optical fiber precursor into a centerline hole of a tube.

15. The method according to claim 14 wherein the tube is comprised of glass soot.

16. The method according to claim 1 wherein the alkali metal oxide doped optical fiber precursor comprises GeO₂.

17. The method according to claim 12 wherein the additional glass comprises F.

18. An optical fiber made from the method according to claim 1 further comprising the step of drawing the optical fiber preform to form an optical fiber.

19. A method according to claim 1 further comprising the step of heating another optical fiber precursor at the same time along with the optical fiber precursor.

20. An optical fiber precursor, comprising:
an elongated silica-containing rod having a length (L) and an outer radius (r), said rod including an alkali dopant wherein a peak concentration of alkali dopant as a function of radius is located within an outer half of the radius (r) of the rod.

21. An optical fiber perform of claim 20 wherein the peak concentration is between 1.0 and 2.0 wt. %.

22. An optical fiber perform of claim 20 wherein no more than 0.5 wt. % of alkali dopant is provided in the an inner half of the radius (r).

23. The optical fiber perform of claim 20 wherein a concentration of alkali metal oxide from a first end to a second end along the length (L) is substantially constant.

24. The optical fiber perform of claim 23 wherein a peak concentration of alkali metal oxide at a first location along the length of the perform is no more than 15% greater than a peak concentration of alkali metal oxide at a second location along the length of the perform.
